(19) United States
(12) Patent Application Publication
(10) Pub. No.: US 2007/0126137 A1
(43) Pub. Date: Jun. 7, 2007

(54) Method of manufacturing integrated bipolar plate/diffuser components for proton exchange membrane fuel cells

(76) Inventors: Aruna Zhamu, Centerville, OH (US); Bor Z. Jang, Centerville, OH (US)

Correspondence Address: Bor Z. Jang, 9436 Parkside Drive, Centerville, OH, 45458, US

(21) Appl. No.: 11/293,690

(22) Filed: Dec. 5, 2005

(51) Int. Cl. C01B 31/02

(52) U.S. Cl. 264/29.1; 264/104; 264/41; 264/81; 264/86; 264/255; 264/105

(57) ABSTRACT

A method of making an integrated bipolar plate/diffuser fuel cell component comprising the steps of: (a) directing a stream of precursor material into a molding tool, wherein the stream of precursor material comprises a mixture of an electrically conductive fiber, a binder, and a carrier fluid; (b) molding the precursor material into a monolithic preform having a porous region having a porous surface, and at least one reactant channel; (c) curing or solidifying the binder to impart a desired level of rigidity to the preform; and (d) infiltrating a portion of the porous region with a matrix material to form a hermetic region of the preform to obtain the bipolar plate/diffuser fuel cell component, wherein the matrix material contains no chemical vapor infiltration carbon. This component can be mass-produced at a fast rate with a relatively low cost. The integrated component has a reduced contact resistance or ohmic loss when used in a fuel cell system.

The present invention is based in part on the research results of a project supported by the DoE SBIR Program. The US government has certain rights on this invention.

### FIELD OF THE INVENTION

The present invention relates to a method of producing integrated bipolar plate/diffuser components for proton exchange membrane fuel cells. The bipolar plate and diffuser functions are combined into a monolithic body that is mass-produced in a net-shape manner.

### BACKGROUND OF THE INVENTION

A fuel cell converts chemical energy into electrical energy and some thermal energy by means of a chemical reaction between a fuel (e.g., hydrogen gas or a hydrogen-containing fluid) and an oxidant (e.g., oxygen). A proton exchange membrane (PEM) fuel cell uses hydrogen or hydrogen-rich reformed gases as the fuel, a direct-methanol fuel cell (DMFC) uses methanol-water solution as the fuel, and a direct ethanol fuel cell (DEFC) uses ethanol-water solution as the fuel, etc. These types of fuel cells that require utilization of a PEM are collectively referred to as PEM-type fuel cells.

A PEM-type fuel cell is typically composed of a seven-layered structure, including (a) a central PEM electrolyte layer for proton transport; (b) two electro-catalyst layers on the two opposite primary surfaces of the electrolyte membrane; (c) two fuel or gas diffusion electrodes (GDEs, hereinafter also referred to as diffusers) or backing layers stacked on the corresponding electro-catalyst layers (each GDE comprising porous carbon paper or cloth through which reactants and reaction products diffuse in and out of the cell); and (d) two flow field plates or bi-polar plates stacked on the GDEs. The flow field plates are typically made of graphite, metal, or conducting composite materials, which also serve as current collectors. Gas-guiding channels are defined on a GDE facing a flow field plate, or on a flow field plate surface facing a GDE. Reactants (e.g., H₂ or methanol solution) and reaction products (e.g., CO₂ at the anode of a DMFC, and water at the cathode side) are guided to flow into or out of the cell through the flow field plates. The configuration mentioned above forms a basic fuel cell unit. Conventionally, a fuel cell stack comprises a number of basic fuel cell units that are electrically connected in series to provide a desired output voltage. If desired, cooling channels and humidifying plates may be added to assist in the operation of a fuel cell stack.

Several of the above-described seven (7) layers may be integrated into a compact assembly, e.g., a membrane-electrode assembly (MEA). An MEA typically includes a polymer electrolyte membrane bonded between two electrodes—an anode and a cathode. Typically, an anode contains an anode backing layer and an electro-catalyst layer, which is positioned between the membrane and the anode backing layer. Similarly, a cathode contains an electro-catalyst layer that exists between the membrane and the cathode backing layer. Hence, an MEA is typically a five-layer structure. Most typically, the two catalyst layers are coated onto the two opposing surfaces of a membrane to form a catalyst-coated membrane (CCM). The CCM is then pressed between a carbon paper layer (the anode backing layer) and another carbon paper layer (the cathode backing layer) to form an MEA. It may be noted that some fuel cell workers refer to a CCM as a MEA, but we prefer to call the catalyst-electrolyte-catalyst structure as a CCM. Commonly used electro-catalysts include noble metals (e.g., Pt), rare-earth metals (e.g., Ru), and their alloys. Known processes for fabricating high performance CCMs and MEAs involve painting, spraying, screen-printing and hot-bonding catalyst layers onto the electrolyte membrane and/or the electrodes.

The bipolar plate and the diffuser described above are typically produced as discrete elements that, along with other layers, require assembly into a unit stack. It would be highly advantageous if a bipolar plate and a diffuser plate (or a bipolar plate and two diffuser plates) can be mass-produced into an integrated assembly. This could significantly reduce the overall fuel cell production costs and reduce contact ohmic losses across bipolar plate-diffuser interfaces. The bipolar plate is known to significantly impact the performance, durability, and cost of a fuel cell system. The bipolar plate, which is typically machined from graphite, is one of the most costly components in a PEM fuel cell.

Besmann, et al. disclosed a carbon/carbon composite-based combined bipolar plate/diffuser (U.S. Pat. No. 6,171,70 (Jan. 9, 2001) and U.S. Pat. No. 6,037,073 (Mar. 14, 2000)), which involves chemical vapor infiltration (CVI) of a carbon matrix into a carbon fiber preform. It is well-known that CVI is a very time-consuming and energy-intensive process and the resulting carbon/carbon composite, although exhibiting a high electrical conductivity, is very expensive.

Accordingly, an object of the present invention is to provide a new method or process to produce improved fuel cells in which the bipolar plate and diffuser are combined into a single monolithic component by using a fast and cost-effective process. The process can be automated and adaptable for mass production. The resulting fuel cell system is of lower cost.

Another object of the present invention is to provide a method to produce a fuel cell stack in which individual fuel cell units are connected in series in such a way that an anode diffuser, a bipolar plate and a cathode diffuser are combined into a single monolithic component between two unit cells, resulting in a less costly construction and lower ohmic losses.

### SUMMARY OF THE INVENTION

The present invention provides a method of producing an integrated bipolar plate/diffuser fuel cell component, which comprises a monolith of electrically conducting, partially impregnated preform material having: (a) a porous region (serving as a diffuser for fuel or oxidant) having a porous surface (in contact with an electro-catalyst) and (b) a hermetic region infiltrated with a matrix material containing no chemical vapor infiltration-densified carbon. The hermetic region defines at least a portion of a coolant channel. It acts to prevent mixing of fuel and oxidant. The porous region defines at least a portion of a reactant channel, as well as a flow field medium for diffusing a reactant to the porous surface. This component can be mass-produced at a fast rate, leading to a reduction in over-all fuel cell cost. The integrated component has a reduced contact resistance or ohmic loss, resulting in a higher output voltage and power. The method comprises the steps of: (a) directing a stream of precursor material into a molding tool, wherein the stream of precursor material comprises a mixture of an electrically conductive fiber, a binder, and a carrier fluid; (b) molding the precursor material into a monolithic preform having a porous region having a porous surface, and at least one reactant channel; (c) curing or solidifying the binder to impart a desired level of rigidity to the preform; and (d) infiltrating a portion of the porous region with a matrix material to form a hermetic region of the preform to obtain the bipolar plate/diffuser fuel cell component. The method does not involve tedious and expensive chemical vapor infiltration of carbon into the preform.

The present invention also provides a method of producing an integrated bipolar plate/diffuser fuel cell component, which comprises a monolith of electrically conducting, partially impregnated preform material having (a) a first porous region having a first porous surface; (b) a second porous region having a second porous surface; and (c) a hermetic region infiltrated with a matrix material containing no chemical vapor infiltration-densified carbon. The hermetic region defines at least one coolant channel and the first porous region defines at least a portion of at least one fuel channel. The second porous region defines at least a portion of at least one oxidant channel. The first porous region further defines a flow field medium for diffusing the fuel to the first porous surface and the second porous region defines a flow field medium for diffusing the oxidant to the second porous surface. This is an integrated component that provides three functions: fuel delivery and distribution, coolant transport, and oxidant delivery and distribution. This component also can be mass produced with a relatively low cost as compared to the process that involves chemical vapor infiltration.

### BRIEF DESCRIPTION OF THE DRAWING

FIG. 1: A sectional view of a prior art PEM fuel cell, wherein a bipolar plate and a diffuser are two separate components.

FIG. 2: A sectional view of single integrated electrode bipolar plate/diffuser in accordance with one preferred embodiment of the present invention.

FIG. 3: Schematic of a molding process for producing an integrated electrode bipolar plate/diffuser in accordance with the present invention: (A) a fiber/binder spraying or slurry shaping procedure, (B) the resulting preform structure, and (C) a preform partially impregnated with a conducting resin.

FIG. 4: A sectional view of an integrated diffuser/bipolar plate/diffuser structure in accordance with another preferred embodiment of the present invention.

FIG. 5: A sectional view of stacked fuel cells using a series of monolithic anode and cathode bipolar plate/diffusers in accordance with the present invention.

### DETAILED DESCRIPTION OF THE INVENTION

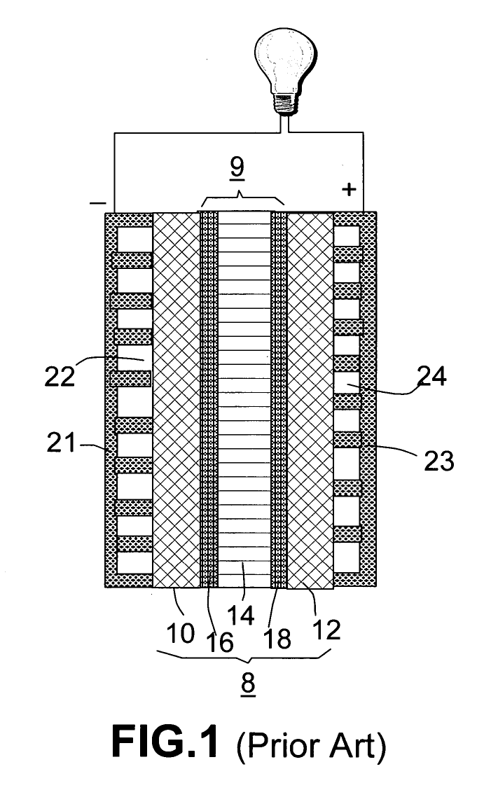

A prior art fuel cell, as shown in FIG. 1, typically comprises a membrane electrode assembly 8, which comprises a proton exchange membrane 14 (PEM), an anode backing layer 10 connected to one face of the PEM 14, and a cathode backing layer 12 connected to the opposite face of PEM 14. Anode backing layer 10 is also referred to as a fluid diffusion layer or diffuser, typically made of carbon paper or carbon cloth. A platinum/ruthenium electro-catalytic film 16 is positioned at the interface between the anode backing layer and PEM 14 for promoting oxidation of the methanol fuel. Similarly, at the cathode side, there are a backing layer or diffuser 12 (e.g., carbon paper or carbon cloth) and a platinum electro-catalytic film 18 positioned at the interface between the cathode backing layer and PEM 14 for promoting reduction of the oxidant.

In practice, the proton exchange membrane in a PEM-based fuel cell is typically coated on both sides with a catalyst (e.g., Pt/Ru or Pt) to form a catalyst-coated membrane 9 (CCM). The CCM layer 9 is then sandwiched between an anode backing layer 10 (diffuser) and a cathode backing layer 12 (diffuser). The resulting five-layer assembly is called a membrane electrode assembly 8 (MEA). Although some fuel cell workers sometimes refer to CCM as a MEA, we prefer to take the MEA to mean a five-layer configuration: anode backing layer, anode catalyst layer, PEM, cathode catalyst layer, and cathode backing layer. Electrodes (anode and cathode) of the MEA have several functions: 1) diffuse oxygen and fuel evenly across the surface, 2) allow water molecules to escape (principally a cathode-side issue), 3) hold back a small amount water to keep the membrane wet and efficient (cathode side issue only), 4) catalyze the reactions, 5) conduct electrons so they can be collected and routed through an electrical circuit, and 6) conduct protons a very short distance to the proton exchange membrane. Both the water management and the electron conduction functions are satisfied with dual role diffusers which are sandwiched over the catalyst layers.

The fuel cell also comprises a pair of fluid distribution plates 21 and 23, which are positioned on opposite sides of membrane electrode assembly 8. Plate 21, which serves as a fuel distribution plate, is shaped to define fuel flow channels 22 facing towards anode diffuser 10. Channels 22 are designed to uniformly deliver the fuel to the diffuser, which directs the fuel to transport to the anode catalyst layer 16. An input port and an output port (not shown), being in fluid communication with channels 22, may also be provided in plate 21 so that carbon dioxide (in a DMFC) can be withdrawn from channels 22.

Plate 23 is shaped to include fluid channels 24 for passage of a quantity of gaseous oxygen (or air). An input port and an output port (not shown) are provided in plate 23, which are in fluid communication with channels 24 so that oxygen (or air) can be transported through the input port to the cathode diffuser 12 and cathode catalyst layer 18, and water and excess oxygen (or air) can be withdrawn from channels 24 through the output port. Plate 23 is electrically conductive and in electrical contact with cathode diffuser 12. It can be used as a uni-polar plate (the positive terminal of the electrical current generated by the fuel cell unit) or a bi-polar plate (if integrated with fuel plate 21).

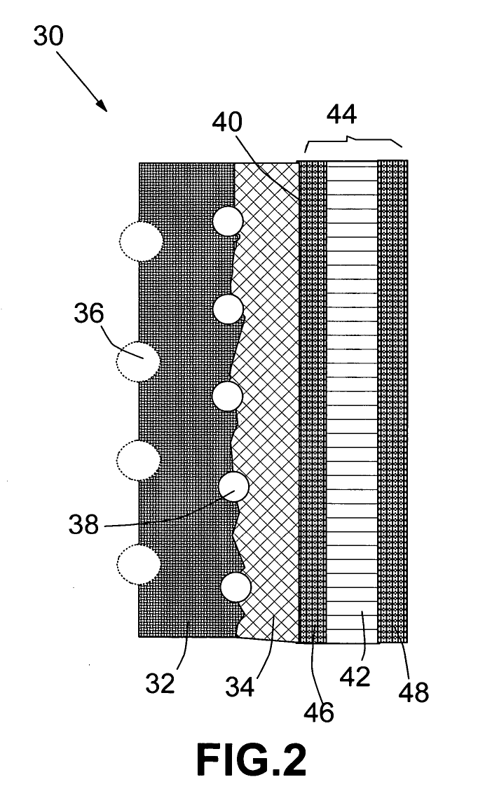

In practice, the diffuser can be integral to a current collector, or a separate piece sandwiched between the current collector and the catalyst layer. As a first preferred embodiment, a method is provided to produce a fuel cell component that features a combined diffuser/current collector, which is hereinafter referred to as an integrated bipolar plate/diffuser. Shown in FIG. 2 is a single monolithic electrode/diffuser fuel cell component 30 that serves as both the bipolar plate and the diffuser of a fuel cell. This component comprises a monolith of electrically conducting, partially impregnated preform material having (a) a porous region 34 having a porous surface 40 and (b) a hermetic region 32 infiltrated with a matrix material containing no chemical vapor infiltration-densified carbon. The hermetic region defines at least a portion of at least one coolant channel 36 and the porous region defines at least a portion of at least one reactant channel 38. The porous region 34, being gas or liquid permeable, defines a flow field medium for diffusing a reactant to the porous surface 40.

The preparation of the component 30 begins with the fabrication of a porous preform from a conductive material, preferably comprising a carbon or graphite fiber. The porous preform allows for good diffusion and distribution of the fuel and oxidant. Various conventional composite preform fabrication techniques can be employed to fabricate a conductive preform—a monolithic body having a desired porosity. In a preferred embodiment of the present invention, the porous preform material is molded to an appropriate shape by conventional slurry molding techniques using chopped or milled carbon fibers of various lengths. In another preferred embodiment, the porous preform can be made by using a fiber/binder spraying technique. These methods can be carried out as follows:

A. Slurry Molding Route:

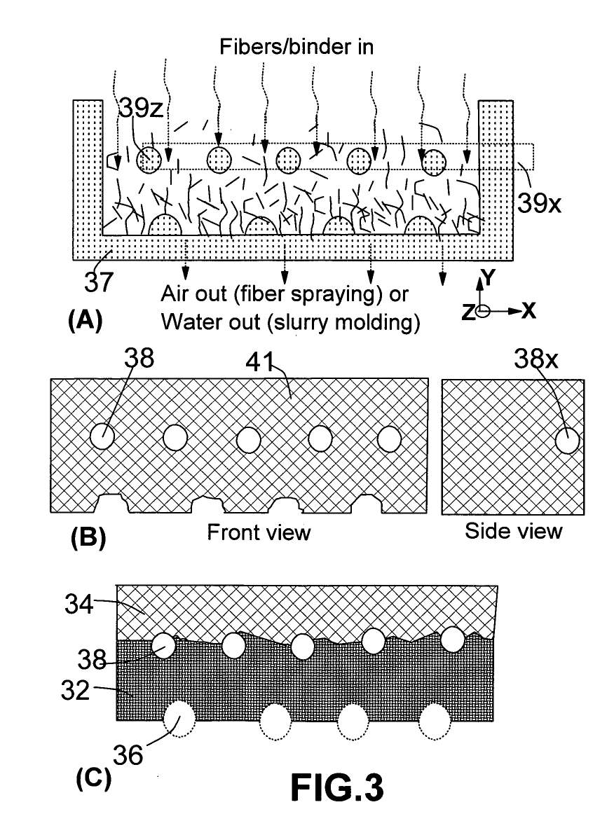

An aqueous slurry is prepared which comprises a mixture of carbon fibers having lengths typically in the range of about 0.1 mm to about 100 mm and about 0.1 wt % to about 10 wt % phenolic resin powder binder. In addition to carbon fibers, or as an alternate to carbon fibers, other conductive ingredient such as metal fibers, carbon nano-tubes, graphitic nano-fibers, nano-scaled graphene plates, expanded graphite plates, carbon blacks, metal particles, or a combination thereof can be a part of the slurry. The slurry is forced through a mold screen of a desired mesh size to trap the solids, thus producing a wet monolithic which is subsequently dried at a temperature of less than 80° C. This mold screen is a part of a mold 37 (FIG. 3(A)) which, along with molding pins (e.g., 39z in the Z-direction and 39x in the X-direction as defined in FIG. 3(A)), helps define the fuel or oxidant transport and distribution channels (e.g., 38, 38x in the resulting preform 41, FIG. 3(B)). The initial porosity, in the slurry molded and dried condition, is typically in the range 70-90%. If necessary, the dried monolith preform is further densified. The phenolic resin binder is cured in shaped graphite molds at a temperature in the range of about 120° C. to about 160° C., preferably about 130° C. Other alternative types of binder material may be used, which serve to provide rigidity or some integrity to the resulting preform prior to partial impregnation. A water-soluble polymer (preferably a water soluble, electrically conductive polymer) can be a good choice since it can be washed away after the desired impregnation of the preform is accomplished. An electrically conductive resin is a good choice for a binder material since it does not have to be removed after matrix impregnation of the preform.

In the above example, only about 0.1 wt % to about 10 wt % binder resin was used for the primary purpose of providing a desired level of rigidity to the fiber preform, prior to the next step of matrix impregnation. Alternatively, a precursor matrix polymer (such as a phenolic resin) of preferably about 20-50 wt % can be used in the above slurry molding process. This resin, if thermosetting, is then cured. If the polymer is a thermoplastic, it is then solidified. A heat treatment procedure (pyrolizing or carbonizing) is then carried out to convert the resin or polymer to carbon for improved conductivity. For the case of a phenolic resin, thermal conversion comprises pyrolizing or carbonizing the resin in an inert atmosphere to a temperature in the range of about 700° C. to about 1300° C., resulting in a total porosity in the range of 40% to 60% and a pore size in the range of about 10 to about 100 microns. After pyrolization, the resulting pores are filled with a conductive matrix material, as opposed to a chemical vapor infiltrated carbon.

B. Fiber/binder spraying route:

The directed fiber spray-up process utilizes an air-assisted chopper/binder guns (or fiber/binder spraying guns) which convey carbon fibers and binder to a molding tool (e.g., a perforated metal screen shaped identical or similar to the part to be molded). In addition to carbon fibers or as an alternate to carbon fibers, other conductive ingredient such as metal fibers, carbon nano-tubes, graphitic nano-fibers, nano-scaled graphene plates, expanded graphite plates, carbon blacks, or a combination thereof can be a part of the air-drive stream of preform ingredients that impinges upon the metal screen. This shaped screen is a part of a mold 37 (FIG. 3(A)), which also contains molding pins (e.g., 39z in the Z-direction and 39x in the X-direction as defined in FIG. 3(A)). These pins will help define the fuel or oxidant transport/distribution channels (e.g., 38, 38x in the resulting preform 41, FIG. 3(B)). The chopped fibers may be held in place on the screen by a large blower drawing air through the screen. Once the desired thickness of reinforcement has been achieved, the chopping system is turned off and the preform is formed by polymerizing or curing the binder. The binder can be an ultraviolet-curable resin. Once stabilized, the preform is cooled and removed from the screen.

The preform prepared by either route can be partially impregnated with a conductive matrix material, not by the expensive and slow chemical vapor infiltration process. Instead, a conductive matrix material, in a melt or solution form, may be used to partially infiltrate the preform 41 to produce a hermetic region 32 while retaining sufficient open porosity in a region 34 (FIG. 3) that remains porous to allow diffusion of the reactant liquids or gasses through the bipolar plate. An optional polymer infiltration and pyrolization procedure may be conducted prior to conductive matrix impregnation. The conductive matrix material may be selected from an intrinsically conductive polymer, a doped polymer, a filled polymer comprising a conductive filler, a petroleum pitch, a coal tar pitch, or a combination thereof. The conductive filler may be selected from small-sized particles (preferably smaller than 10 μm and more preferably smaller than 1 μm) such as a carbon black, expanded graphite plate, graphite particle, nano-scaled graphene plate, graphitic nano-fiber, metal particle, or a combination thereof.

In either the slurry molding or directed fiber/binder spraying process, a fluid is used as the flow medium with individual fibers suspended in this medium, which is water or air. It has been observed that when the slurry (a mixture of fibers, water, binder powder) or the compressed air-fiber stream (a mixture of fibers, binder, and air) is directed to flow from a larger-diameter zone of a channel to a smaller-diameter zone, the resulting preform exhibits a structure with a majority of fibers being preferentially oriented along the flow direction. This is advantageous in terms of electrical conductivity since the conductivity of carbon fibers is known to be much higher along the fiber axis direction than that along the transverse (fiber diameter) direction by 2-4 orders of magnitude. The electrical conductivity of carbon fiber (approximately 50% by volume)-polyaniline composite bipolar plates with a preferred fiber orientation along the plate thickness direction was found to be in the range of 200-300 S/cm, which is comparable to the conductivity range of carbon-carbon composites with randomly oriented short fibers. This implies that there is no need to create a carbon/carbon composite using a time-consuming and energy-intensive chemical vapor infiltration process, which is very expensive. Comparable polymer matrix composites with randomly oriented fibers exhibit a conductivity range of 25-95 S/cm. Besides carbon fibers, other preform materials such as metal fibers, carbon nano-tubes, graphitic nano-fibers, nano-scaled graphene plates, and expanded graphite plates can also be substantially oriented along a direction perpendicular to the bipolar plate (along the plate thickness direction).

The conducting preform material may comprise carbon fibers, metal fibers, carbon nano-tubes, graphitic nano-fibers, nano-scaled graphene plates, expanded graphite plates, carbon blacks, or a combination thereof. Individual nano-scaled graphite planes (individual graphene sheets) and stacks of multiple nano-scaled graphene sheets are collectively called nano-sized graphene plates (NGPs). The structures of these materials may be best visualized by making a longitudinal scission on the single-wall or multi-wall of a nano-tube along its tube axis direction and then flattening up the resulting sheet or plate. These nano materials have strength, stiffness, and electrical conductivity that are comparable to those of carbon nano-tubes, but NGPs can be mass-produced at lower costs. They can be produced by reducing the expanded graphite to much smaller sizes (100 nanometers or smaller).

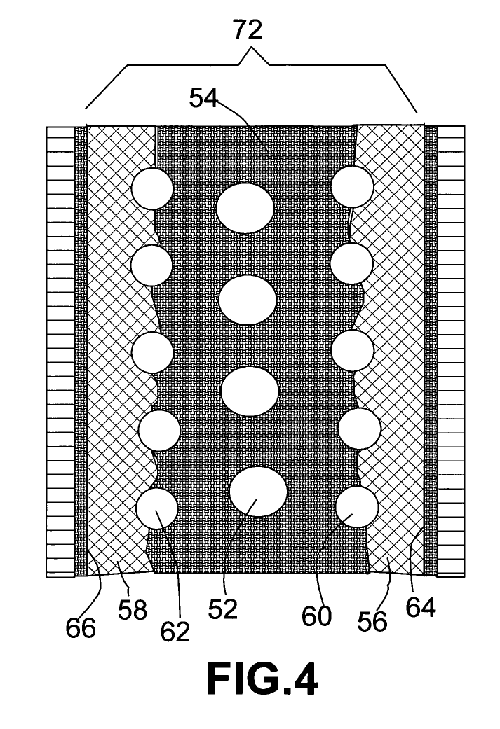

A preferably planar region of the preform is impregnated or densified to a non-porous hermetic state and is called the hermetic region 32. It is necessary to seal a region of the monolith that contains the coolant channels 36 in order to contain coolant therein and to prevent transport of fuel or oxidant toward the wrong electrode of the fuel cell. For example, the non-porous region 32 which is to be densified can be simply immersed in a resin bath with a proper resin level, allowing the resin to permeate through the pores and move upward to a desired level. Alternatively, the matrix material may be introduced into the bottom portion 32 (FIG. 4(C)) using a low-pressure liquid transfer molding process by first filling the bottom portion of the preform with a desired amount of the matrix material, allowing the matrix liquid to rise up to a desired level. When sufficient infiltration has occurred the region becomes hermetic. The matrix material used to impregnate the preform may comprise an electrically conductive material selected from an intrinsically conductive polymer, a doped polymer, a filled polymer comprising a conductive filler, a petroleum pitch, a coal tar pitch, or a combination thereof. The conductive filler may be selected from carbon nano-tubes, graphitic nano-fibers, nano-scaled graphene plates, expanded graphite plates, carbon blacks, or a combination thereof. Intrinsically conductive polymers include those conjugated polymers that have overlapping molecular orbitals for electron conduction, such as polypyrrole and polyaniline. These polymers are made more conducting, or “doped,” by reacting the conjugated semiconducting polymer with an oxidizing agent, a reducing agent, or a protonic acid, resulting in highly delocalized polycations or polyanions. The conductivity of these materials can be tuned by chemical manipulation of the polymer backbone, by the nature of the dopant, by the degree of doping, and by blending with other polymers. In addition, polymeric materials are lightweight, easily processed, and flexible.

The remaining un-impregnated region of the preform material remains porous and is called the porous region 34, which is also preferably planar. In addition, the hermetic region defines coolant channels 36, and the porous region defines at least portions of reactant channels 38. The depth of the hermetic region 32 is controlled during fabrication to avoid surrounding and subsequently sealing the reactant channels 38. The hermetic region 32 acts as a seal, preventing any flow of reactant away from the porous surface 40 while also preventing any flow of coolant toward reactant channels 38 or porous surface 40. The porous region 34 further defines a flow field medium for diffusing a reactant (fuel or oxidant) to a porous surface 40, which is in physical contact with a catalyst layer (e.g., 46).

In summary, a cost-effective method of making an integrated bipolar plate/diffuser fuel cell component has been developed. The method comprises the steps of: (a) directing a stream of precursor material into a molding tool, wherein the stream of precursor material comprises a mixture of an electrically conductive fiber, a binder, and a carrier fluid; (b) molding the precursor material into a monolithic preform having a porous region having a porous surface, and at least one reactant channel; (c) curing or solidifying the binder to impart a desired level of rigidity to the preform; and (d) infiltrating a portion of the porous region with a matrix material to form a hermetic region of the preform to obtain the bipolar plate/diffuser fuel cell component, wherein the matrix material contains no chemical vapor infiltration carbon. The presently invented method can be used to produce an integrated bipolar plate/diffuser fuel cell component that further contains coolant channels.

The component 30 (FIG.2) may be subsequently attached to the opposite electrode of a second cell in a conventional series. In this situation, coolant channels 36 can be formed as partial channels on a surface of the component as grooves which align with similar grooves in an opposing fuel cell component to form complete coolant channels. Thus, one can see that the present invention provides the combination of two components, the bipolar plate and the diffuser, into a single, simply fabricated monolithic component.

Another embodiment of the present invention is to combine or integrate two components as described above. As shown in FIG. 4, back-to-back bipolar plate/diffusers are fabricated as one monolithic component 72, with coolant channels 52 formed as complete channels within the component, as well as reactant channels 60 & 62. The procedure is similar to that described earlier, which involves a preform molding procedure via slurry molding or directed fiber/binder spraying, an optional preform rigidization step, an optional resin pyrolization step, and matrix impregnation. The hermetic region 54 defines coolant channels 52. Since there are two porous regions 56, 58 in this embodiment, impregnation to form the hermetic region 54 is preferably accomplished by flowing the stream of liquid matrix material through the coolant channels. It is of interest to note that the liquid matrix material is capable of diffusing outwardly toward the fuel and oxidant directions largely due to capillarity force, leaving behind very little matrix material in the coolant channels 52 which are not clogged up. The porous regions and the hermetic region are preferably made to be planar. Optionally, coolant channels may be fitted with connectors, preferably before the matrix material is solidified.

Fuel channels 60 and oxidant channels 62 are at least partially defined by the two respective porous regions 56, 58 which further define flow field media for diffusing a fuel and oxidant in opposite directions to respective porous surfaces 64, 66 upon which are disposed respective electro-catalyst layers. One can see that the present invention further provides the combination into one component of two opposing integrated bipolar plate/diffuser components taught in the first embodiment; i.e., two sets of bipolar plates and diffusers (four discrete components) have been combined into one component.

In summary, this method of making an integrated bipolar plate/diffuser fuel cell component comprises the steps of: (a) directing a stream of precursor material into a molding tool, wherein the stream of precursor material comprises a mixture of an electrically conductive fiber, a binder, and a carrier fluid (which is water in slurry molding or compressed air in directed fiber/binder spraying); (b) molding the precursor material into a monolithic preform having: a first porous region having a porous surface, a second porous region having a porous surface, an intended hermetic region between the first and second porous regions, at least one reactant channel, and at least one oxidant channel; (c) curing or solidifying the binder to impart a desired level of rigidity to the preform; and (d) infiltrating the intended hermetic region with a matrix material to form the bipolar plate/diffuser fuel cell component, wherein the matrix material contains no chemical vapor infiltration carbon.

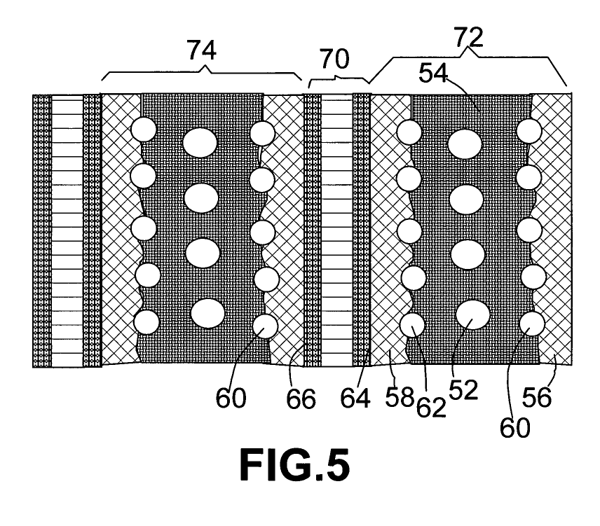

FIG.5 shows two such components 72,74 in a stacked arrangement. Fuel from a fuel channel 60 of one component 74 and oxidant from an oxidant channel 62 of the next component 72 flow toward each other and react at the catalyst/electrolyte interfaces of the catalyst-coated membrane (CCM) 70 to produce electricity. Such an arrangement is simple since only two components are necessary to complete a unit cell in the stack: the bipolar plate/diffusers 72 and the CCM 70. Additional advantages of the invention include avoidance of deleterious fluid leaks and ohmic losses generally associated with conventional discrete bipolar plate and diffuser arrangements which require multiple discrete components for each unit in the stack thereof. In addition, the integrated monolithic bipolar plate/diffuser component can be manufactured using mass-production processes, resulting in lower costs of PEM fuel cells. These fuel cells are useful in power production facilities, electric vehicles, auxiliary power for vehicles, and backup power systems.

The present invention also provides a fuel cell that comprises an integrated bipolar plate/diffuser fuel cell component as defined in any of the aforementioned three preferred embodiments. The resulting fuel cells are of lower costs (due to their amenability to mass production) and better performance (since lower contact resistance means higher voltage).

The PEM used in the present invention can be selected from perfluorinated sulfonic acids such as Nafion® (DuPont Chemical Co.), which is normally used up to approximately 60° C. However, for higher temperature operations, the following higher temperature polymers may be used: sulfonated poly (ether ether ketone), sulfonated poly (ether sulfone), sulfonated perfluoroalkoxy, polybenzimidazole, sulfonated polyimide, sulphonated polyamide-imide, sulfonated poly phenylene oxide, and copolymers and mixtures thereof.

In addition to Pt, many other types of oxidation and reduction electro-catalysts may be used. For example, instead of a platinum/ruthenium oxidation electro-catalyst, one may use as the oxidation electro-catalyst (i) the combination of platinum and any other one or more metals from Groups IIIA, IVA, VA, IB, IIB, IIIB, IVB, VB, VIB, VIIB, and VIIIB of the periodic table; (ii) metal oxides of the above-mentioned combination including reduced metal oxides of the combination; or (iii) mixtures and/or alloys thereof. Instead of a platinum reduction electro-catalyst, one may use as the reduction electro-catalyst metal oxides of platinum, including reduced metal oxides of platinum, or mixtures and/or alloys thereof. The oxidation or reduction electro-catalyst may be applied directly to the backing layer of its respective electrode or may be dispersed on a suitable catalyst support, such as a carbon or other electrically conductive support (e.g., carbon black particles), which is in turn applied directly to the backing layer of its respective electrode. Other reduction electro-catalysts known to those skilled in the art, such as sodium platinate, tungsten bronzes, lead ruthenium oxides, lead iridium oxides, lanthanum oxide and macrocyclic or porphyrin structures containing one or more metals, could also be used.

What is claimed is:

1. A method of making an integrated bipolar plate/diffuser fuel cell component comprising the steps of:
(a) directing a stream of precursor material into a molding tool, wherein said stream of precursor material comprises a mixture of an electrically conductive fiber, a binder, and a carrier fluid;
(b) molding said precursor material into a monolithic preform having:
a porous region having a porous surface, and
at least one reactant channel;
(c) curing or solidifying said binder to impart a desired level of rigidity to said preform; and
(d) infiltrating a portion of said porous region with a matrix material to form a hermetic region of said preform to obtain the bipolar plate/diffuser fuel cell component, wherein said matrix material contains no chemical vapor infiltration carbon.

2. The method of claim 1 wherein said porous region and said hermetic region are generally planar.

3. The method of claim 1 wherein said precursor material is an aqueous slurry comprising a mixture of carbon fibers having lengths typically in the range of about 0.1 mm to about 100 mm and a resin binder typically in the range of about 0.1% to about 10%.

4. The method of claim 1 wherein said precursor material comprises a mixture of carbon fibers having lengths typically in the range of about 0.1 mm to about 100 mm and a resin binder typically in the range of about 20% to about 50% and further comprises a step, after step (c) but before step (d), of thermally converting said resin binder to a polymeric carbon.

5. The method of claim 4 wherein said step of thermal conversion comprises pyrolizing or carbonizing said resin binder in an inert atmosphere to a temperature in the range of about 700° C. to about 1300° C., resulting in a total porosity in the range of 40% to 60% and a pore size in the range of about 10 to about 100 microns.

6. The method of claim 1 wherein said molding step is slurry molding.

7. The method of claim 1 wherein said step of directing a stream of precursor material comprises directing said precursor material to impinge upon a surface of said molding tool at a substantially perpendicular angle.

8. The method of claim 1 wherein said step of directing a stream of precursor material comprises directing said precursor material to flow from a first zone of a flow channel to a second zone with a narrower opening prior to impinging upon a surface of said molding tool to facilitate a preferential orientation of fibers in said preform.

9. The method of claim 1 wherein said monolithic preform further defines at least a portion of a coolant channel.

10. The method of claim 1 wherein said precursor material comprises carbon fibers, metal fibers, carbon nano-tubes, graphitic nano-fibers, nano-scaled graphene plates, expanded graphite plates, carbon blacks, metal particles, or a combination thereof.

11. The method of claim 1 wherein said matrix material comprises an electrically conductive material selected from an intrinsically conductive polymer, a doped polymer, a filled polymer comprising a conductive filler, a petroleum pitch, a coal tar pitch, or a combination thereof.

12. The method of claim 11 wherein said conductive filler is selected from a carbon black, expanded graphite plate, graphite particle, nano-scaled graphene plate, graphitic nano-fiber, metal particle, or a combination thereof.

13. A method of making an integrated bipolar plate/diffuser fuel cell component comprising the steps of:
(a) directing a stream of precursor material into a molding tool, wherein said stream of precursor material comprises a mixture of an electrically conductive fiber, a binder, and a carrier fluid;
(b) molding said precursor material into a monolithic preform having:
a first porous region having a porous surface,
a second porous region having a porous surface,
an intended hermetic region between said first and second porous regions,
at least one reactant channel, and
at least one oxidant channel;
(c) curing or solidifying said binder to impart a desired level of rigidity to said preform; and
(d) infiltrating said intended hermetic region with a matrix material to form the bipolar plate/diffuser fuel cell component, wherein said matrix material contains no chemical vapor infiltration carbon.

14. The method of claim 13 wherein said first porous region, said second porous region, and said hermetic region are generally planar.

15. The method of claim 13 wherein said precursor material is an aqueous slurry comprising a mixture of carbon fibers having lengths typically in the range of about 0.1 mm to about 100 mm and a binder resin typically in the range of about 0.1% to about 10%.

16. The method of claim 13 wherein said precursor material comprises a mixture of carbon fibers having lengths typically in the range of about 0.1 mm to about 100 mm, a resin binder typically in the range of about 20% to about 50% and further comprises a step, after step (c) but before step (d), of thermally converting said resin binder to a polymeric carbon.

17. The method of claim 16 wherein said step of thermal conversion comprises pyrolizing or carbonizing said resin binder in an inert atmosphere to a temperature in the range of about 700° C. to about 1300° C., resulting in a total porosity in the range of 40% to 60% and a pore size in the range of about 10 to about 100 microns.

18. The method of claim 13 wherein said molding step is slurry molding.

19. The method of claim 13 wherein said step of directing a stream of precursor material comprises directing said precursor material to impinge upon a surface of said molding tool at a substantially perpendicular angle.

20. The method of claim 13 wherein said step of directing a stream of precursor material comprises directing said precursor material to flow from a first zone of a flow channel to a second zone with a narrower opening prior to impinging upon a surface of said molding tool.

21. The method of claim 13 wherein said precursor material comprises carbon fibers, metal fibers, carbon nano-tubes, graphitic nano-fibers, nano-scaled graphene plates, expanded graphite plates, carbon blacks, metal particles, or a combination thereof.

22. The method of claim 13 wherein said matrix material comprises an electrically conductive material selected from an intrinsically conductive polymer, a doped polymer, a filled polymer comprising a conductive filler, a petroleum pitch, a coal tar pitch, or a combination thereof.

23. The method of claim 22 wherein said conductive filler is selected from a carbon black, expanded graphite plate, graphite particle, nano-scaled graphene plate, graphitic nano-fiber, metal particle, or a combination thereof.
